(19) United States
(12) Patent Application Publication
(10) Pub. No.: US 2008/0274375 A1
(43) Pub. Date: Nov. 6, 2008

(54) Anodizing Aluminum and Alloys Thereof

(75) Inventors: Fuk Chiu Ng, Hong Kong (HK); Shu Chung Li, Surrey (GB)

Correspondence Address: TROUTMAN SANDERS LLP, 600 PEACHTREE STREET , NE, ATLANTA, GA, 30308, US

(73) Assignee: DURACOUCHE INTERNATIONAL LIMITED, Tortola (VG)

(21) Appl. No.: 11/744,829

(22) Filed: May 4, 2007

(51) Int. Cl. C25D 11/12; B32B 15/00; C25D 11/18; C25D 21/10

(52) U.S. Cl. 428/687; 205/148; 205/229; 205/330; 428/544

(57) ABSTRACT

This invention encompasses methods of producing a colored oxide layer on an aluminum material by anodizing the aluminum material in an electrolyte comprising water, sulfuric acid and oxalic acid. The anodizing step comprises passing at least two sequential current densities through the electrolyte. Methods of making and using article with a colored oxide layer on an aluminum material make by the methods disclosed herein are also disclosed.

### FIELD OF THE INVENTION

This invention encompasses methods of producing a colored oxide layer on an aluminum material. In particular, this invention encompasses methods of producing a colored oxide layer by anodizing an aluminum material in an electrolyte comprising sulfuric acid and oxalic acid.

### BACKGROUND OF THE INVENTION

Aluminum and its alloys are known for their desirable properties such as light weight, strength, durability and fabrication flexibility. In 1889, Alcoa, Inc. was granted a patent (i.e., U.S. Pat. No. 400,664) for an electrolytic process of making aluminum from aluminum oxide, which substantially lowered the cost of making aluminum. Since then, because of their desirable properties and low costs, aluminum and its alloys have been widely used in many industries such as aerospace, transportation, building, semiconductor and electronic. As a result, the global use of aluminum exceeds that of any other metal except iron in terms of both quantity and value.

Some of the many uses for aluminum metal and alloys include parts or components for various goods such as watches, computers (e.g., heat sinks for CPUs), computer related products (e.g., casings for hard drives and flash drives), televisions, radios, refrigerators, air-conditioners, transportation vehicles (e.g., automobiles, aircraft, trucks, railroad cars, marine vessels, bicycles, etc.), packaging materials (e.g cans, foil, etc.), building products (e.g windows, doors, siding, building wire, etc.), cooking utensils, electrical transmission lines, MKM steel and Alnico magnets, and the like.

In addition to their desirable properties mentioned above, aluminum metal and alloys can be anodized to enhance their corrosion resistances, abrasion resistances, electrical insulation properties, adhesion properties, and/or aesthetic properties. In general, anodizing is an electrochemical process that thickens and toughens the naturally occurring protective oxide layer of aluminum or an aluminum alloy. The resulting oxide layer or anodic coating, depending on the process, may be the second hardest substance known to man, perhaps second only to diamond. The oxide layer generally has a porous structure which can allow secondary infusions (i.e. organic and inorganic coloring, lubricity aids, etc.) for surface modifications.

The aluminum anodizing process may include batch, continuous coil, continuous parts and basket anodizing. These anodizing processes not only can form decorative or protective coatings with a wide selection of colors that can rival other techniques such as painting, lacquering and physical vapor deposition (PVD), but also can provide the technical advantages and beauty of anodizing that these other techniques cannot match. For example, painting and lacquering are generally not durable and may fail to comply with the Restriction of Hazardous Substances Directive (RoHS) adopted by the European Union for restricting heavy metals and toxic substances. On the other hand, the PVD process may not provide desirable color choices in some instances, as well as the required process stability in mass production.

Although a variety of anodizing processes have been developed, there are three main variations of aluminum anodizing, i.e., chromic anodizing, sulfuric anodizing, and hardcoat anodizing. The anodizing process is described in S. Kawai, “Anodizing and Coloring of Aluminum Alloys,” ASM International (2002), which is incorporated herein by reference.

Chromic anodizing is commonly referred to as Type 1 anodizing. It can be carried out in an electrolytic solution comprising chromic acid at a temperature about 40° C. and a current density from about 0.15 A/dm² to about 0.45 A/dm². The process generally takes from about 40 minutes to about 60 minutes. Chromic anodizing generally yields a thin oxide layer with a thickness from about 1 micron to about 2.5 microns. Because chromic acid is less corrosive than sulfuric acid, chromic anodizing can be used for complex parts which are difficult to be rinsed. Chromic anodizing may also reduce the fatigue strength of the aluminum less than the other methods described herein.

Sulfuric anodizing is commonly referred to as Type II anodizing. It can be performed using an electrolytic solution comprising sulfuric acid at a temperature about 25° C. and a current density from about 1.0 A/dm² to about 1.5 A/dm². The process generally takes from about 30 minutes to about 60 minutes, depending on the alloy used. The sulfuric anodizing generally yields an oxide layer with a thickness from about 10 microns to about 14 microns. The Type II designation is used for indicating a sulfuric anodize whereas Class 1 under Type II designation is used to specify natural color or no dye, and Class 2 is used to indicate a dye.

Hardcoat anodizing is commonly referred to as Type III anodizing. Type III oxide layers are generally produced at a very low temperature and high current density. For example, Type III anodizing can be carried out in an electrolytic solution comprising sulfuric acid at a temperature from about 0° C. to about 5° C. and a current density from about 3.5 A/dm² to about 4.0 A/dm². The process generally takes from about 20 minutes to about 120 minutes. The hardcoat anodizing generally yields an oxide layer with a thickness from about 30 microns to about 60 microns.

Although the anodizing processes offer advantages over other techniques and can provide decorative oxide layers having one or more colors with or without dyeing, the anodizing processes, such as the Type II and Type III processes, suffer from some drawbacks. For example, the Type III anodizing process generally provides hard and opaque oxide layers that may be difficult to be dyed and polished. Further, the Type II anodizing process, may not generate an oxide layer hard and/or shinny enough for some decorative coating applications. Further, the Type II anodic oxide layer can dissolve in the corrosive anodizing bath so that the thickness of the Type II oxide layer may be limited. Even though the corrosion may not be significant in thicker workpieces, the corrosion can still roughen the surfaces and generate surface defects, such as flow marks, teardrops, etched trenches and the like, in the oxide layer.

To overcome the above-mentioned drawbacks of the painting, lacquering, PVD, and conventional anodizing techniques, there is a need for an improved technique of surface treating aluminum materials to provide hard and durable anodized surfaces that can be dyed and mirror finished for various decorative and/or protective applications.

### SUMMARY OF THE INVENTION

Provided herein are methods of producing a colored oxide layer on an aluminum material comprising anodizing the aluminum material with two different current densities. Embodiments of the fuel compositions disclosed herein are believed to satisfy the above-mentioned needs. In one aspect, provided herein are methods of producing the colored oxide layer on an aluminum material comprising the steps of:
(a) placing the aluminum material as an anode in an electrolyte comprising water, oxalic acid, and sulfuric acid; and
(b) anodizing the aluminum material with a first current having a density of less than 0.5 A/dm² for a time period from about 1 minute to about 1 hour; and then with a second current having a density from about 1.5 A/dm² to about 2.5 A/dm² to produce an oxide layer.

In some embodiments, the aluminum material is further anodized with a third current having a density from 1.0 A/dm² to about 1.5 A/dm². In further embodiments, each of the first, second and third currents is independently generated by a constant direct current or pulsed direct current.

In some embodiments, the methods further comprise agitating the electrolyte with an agitation device. In further embodiments, the agitation device comprises agitation tubes.

In some embodiments, the methods further comprise forming a dye layer on the oxide layer. In other embodiments, the electrolyte further comprises aluminum ion, a metal sulfate, organic acid or a combination thereof. In further embodiments, the electrolyte further comprises from about 2 g to about 11 g of aluminum ion per liter of the electrolyte.

In certain embodiments, the electrolyte comprises from about 5 g to about 40 g of oxalic acid per liter of the electrolyte, and from about 100 g to about 360 g of sulfuric acid per liter of the electrolyte. In other embodiments, the electrolyte comprises from about 12 g to about 20 g of oxalic acid per liter of the electrolyte, and from about 140 g to about 220 g of sulfuric acid per liter of the electrolyte. In further embodiments, the electrolyte comprises from about 14 g to about 18 g of oxalic acid per liter of the electrolyte, and from about 160 g to about 200 g of sulfuric acid per liter of the electrolyte.

In some embodiments, the anodizing step is performed at a temperature from about 5° C. to about 25° C. In further embodiments, the anodizing step is performed at a temperature from about 10° C. to about 15° C.

In some embodiments, the aluminum material comprises aluminum and optionally an element selected from the group consisting of silicon, boron, germanium, arsenic, antimony, tellurium, copper, magnesium, manganese, zinc, lithium, iron, chromium, vanadium, titanium, bismuth, gallium, tin, lead, zirconium, nickel, cobalt and combinations thereof.

In another aspect, provided herein are articles comprising an aluminum material having a colored oxide layer on the aluminum material, wherein the colored oxide layer is prepared by a method comprising the steps of:

(a) placing the aluminum material as an anode in an electrolyte comprising water, oxalic acid, and sulfuric acid; and

(b) anodizing the aluminum material with a first current having a density of less than 0.8 A/dm² for a time period from about 1 minute to about 1 hour; and then with a second current having a density from about 1.5 A/dm² to about 2.5 A/dm² to produce an oxide layer.

In some embodiments, the colored oxide layer has a microhardness value from about 280 Hv to about 1000 Hv. In other embodiments, the colored oxide layer has a thickness from about 15 microns to about 50 microns. In further embodiments, the article further comprises a dye layer on the oxide layer. In certain embodiments, the surface of the colored oxide layer has an Ra value from about 0.01 microns to about 0.1 microns.

### DESCRIPTION OF THE DRAWINGS

FIG. 1 depicts an anodic oxide layer on an aluminum substrate wherein the anodic oxide layer comprises anodic cells, each of which has a pore.

FIG. 2 depicts the surface colors and finishes of Example 1, Comparative Example D and Comparative Example E.

### DEFINITIONS

As used herein, a “substantially pure” metal refers to a metal or an alloy that is substantially free of one or more other elements or compounds, i.e., the metal or alloy contains greater than 80 wt. %, greater than 90 wt. %, greater than 95 wt. %, greater than 96 wt. %, greater than 97 wt. %, greater than 98 wt. %, greater than 99 wt. %, greater than 99.5 wt. %, greater than 99.6 wt. %, greater than 99.7 wt. %, greater than 99.8 wt. %, or greater than 99.9 wt. % of the metal or alloy; or less than 20 wt. %, less than 10 wt. %, less than 5 wt. %, less than 3 wt. %, less than 1 wt. %, less than 0.5 wt. %, less than 0.1 wt. %, or less than 0.01 wt. % of the one or more other elements or compounds, based on the total weight of the metal or alloy.

As used herein, a metal or alloy that is “substantially free” of an element or a compound refers to that the metal or metal alloy contains less than 20 wt. %, less than 10 wt. %, less than 5 wt. %, less than 4 wt. %, less than 3 wt. %, less than 2 wt. %, less than 1 wt. %, less than 0.5 wt. %, less than 0.1 wt. %, or less than 0.01 wt. % of the element or compound, based on the total weight of the metal or alloy.

As used herein, an alloy refers to a material made up of two or more metals. Generally, alloys are designed and produced to have certain specific, desirable characteristics, including strength, formability, and corrosion resistance.

As used herein, Ra refers to the arithmetic average deviation of the absolute values of the roughness profile from the mean line or centerline, also know as the centerline average roughness (CLA). The centerline divides profiles such that all areas above it equal all areas below it.

As used herein, Rq refers to the root-mean-square or geometric average deviation of the roughness profile from the mean line measured in the sampling length.

As used herein, the term “buffing” or “polishing” refers to the process of smoothing a workpiece such as metals or alloys to a bright, smooth mirror-like finish.

In the following description, all numbers disclosed herein are approximate values, regardless whether the word “about” or “approximate” is used in connection therewith. They may vary by 1 percent, 2 percent, 5 percent, or, sometimes, 10 to 20 percent. Whenever a numerical range with a lower limit, R^{L}, and an upper limit, R^{U}, is disclosed, any number falling within the range is specifically disclosed. In particular, the following numbers within the range are specifically disclosed: R=R^{L}+k*(R^{U}−R^{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed.

### DESCRIPTION OF EMBODIMENTS OF THE INVENTION

Disclosed herein are methods of producing an oxide layer on an aluminum material comprising the steps of: (a) suspending the aluminum material as an anode in an aqueous electrolyte comprising water, oxalic acid, and sulfuric acid; and (b) anodizing the aluminum material with a first current density of less than 0.8 A/dm² for a time period from about 1 minute to about 4 hours; and then with a second current density from about 1.5 A/dm² to about 2.5 A/dm² to produce an oxide layer.

Disclosed also herein are articles comprising an aluminum material having an oxide layer on the aluminum material wherein the oxide layer is prepared by a method comprising the steps of: (a) suspending the aluminum material as an anode in an aqueous electrolyte comprising water, oxalic acid, and sulfuric acid; and (b) anodizing the aluminum material with a first current density of less than 0.8 A/dm² for a time period from about 1 minute to about 1 hour; and then with a second current density from about 1.5 A/dm² to about 2.5 A/dm² to produce an oxide layer. In some embodiments, the oxide layer is colored. In other embodiments, the oxide layer is opaque and colored. In further embodiments, the oxide layer is transparent and colored.

The articles disclosed herein can be made into or used as parts or components in various products such as pens, lighters, watches, computers, computer related products (e.g., hard drives, flash drives, DVD drives and the like), printers, copiers, fax machines, televisions, radios, refrigerators, air-conditioners, transportation vehicles, packaging materials, building products, cooking utensils, architectural finishes and trims, machines, or in any other areas where the decorative and special physical properties of hard coated aluminum are required.

The aluminum materials suitable for the methods and articles disclosed herein can be aluminum metal which is substantially free of other elements or compounds or any aluminum alloy known in the art. Although aluminum metal is desirable in many applications, it is more suitable to use aluminum alloys in some applications for their modified chemical, physical and mechanical properties over those of the aluminum metal. Generally, aluminum alloys can be formed by combining aluminum with other elements by a thermo-mechanical process. A brief historical overview of alloys and manufacturing technologies is described in the articles by Joseph R. Davis, “Aluminum and Aluminum Alloys,” ASM International, (1993); and R. E. Sanders, “Technology Innovation in Aluminium Products,” The Journal of The Minerals, 53(2), pp. 21-25 (2001), both of which are incorporated herein by reference in their entirety.

Generally, aluminum alloys display significantly improved mechanical properties such as high strength-to-weight ratio, especially when the aluminum alloys are tempered. Although many bulk metal materials are loosely referred to as “aluminum,” actually many of them are aluminum alloys instead. For example, most aluminum foils are alloys comprising about 92 wt. % to about 99 wt. % of aluminum.

In some embodiments, the aluminum material used herein is aluminum metal which is substantially free of other elements such as copper, zinc, magnesium, manganese, silicon, lithium, iron, chromium, vanadium, titanium, bismuth, gallium, lead, zirconium, and combinations thereof. In certain embodiments, the aluminum material comprises more than about 95 wt. % of aluminum, more than about 96 wt. % of aluminum, more than about 97 wt. % of aluminum, more than about 98 wt. % of aluminum, more than about 99 wt. % of aluminum, more than about 99.5 wt. % of aluminum, more than about 99.9 wt. % of aluminum or more than about 99.99 wt. % of aluminum, based on the total weight of the aluminum material. In certain embodiments, the aluminum material comprises about 99 wt. % or more of aluminum, based on the total weight of the aluminum material. Some non-limiting examples of aluminum include the 1000 series aluminum metals, such as 1060 and 1100 in Table 1 below.

In other embodiments, the aluminum materials used herein are aluminum alloys. Aluminum readily forms alloys with semimetals, metals and combinations thereof. Some non-limiting examples of suitable semimetals include silicon, boron, germanium, arsenic, antimony, tellurium and the like. Some non-limiting examples of suitable metals include copper, zinc, magnesium, manganese, lithium, iron, chromium, vanadium, titanium, bismuth, gallium, lead, zirconium and the like. In general, copper can increase the strength, hardness and heat-treatability; magnesium can increase the tensile strength, resistance to marine corrosion, weld ability and hardness; manganese can increase the strength and resistance to corrosion; silicon can lower the melting point and improve castability; and zinc can improve the strength and hardness of the alloys.

There are many aluminum alloys which are classified by many different organizations. For example, some common aluminum alloy compositions are registered with the Aluminum Association. On the other hand, many other organizations publish more specific standards for the manufacture of aluminum alloy, including the Society of Automotive Engineers standards organization and the ASTM. Alternatively, aluminum alloys can be classified by a number system (e.g., ANSI) or by names indicating their main alloying constituents (e.g., DIN and ISO).

The aluminum alloys used herein may comprise aluminum and a non-aluminum component comprising at least one or more semimetals and other metals. In some embodiments, the semimetals and other metals include silicon, boron, germanium, arsenic, antimony, tellurium, copper, magnesium, manganese, zinc, lithium, iron, chromium, vanadium, titanium, bismuth, gallium, tin, lead, zirconium, nickel, cobalt and combinations thereof. In certain embodiments, the aluminum alloy comprises more than about 85% of aluminum, more than about 87 wt. % of aluminum, more than about 90% of aluminum, more than about 92 wt. % of aluminum, more than about 93 wt. % of aluminum, more than 94 wt. % of aluminum, or more than 95 wt. % of aluminum, based on the weight of the aluminum alloy. In certain embodiments, the aluminum alloy comprises more than about 1 wt. %, more than about 2 wt. %, more than about 3 wt. %, more than about 4 wt. %, more than about 5 wt. %, more than 6 wt. %, or more than 7 wt. % of the non-aluminum component, based on the total weight of the aluminum alloy.

In further embodiments, the aluminum alloy is an alloy comprising aluminum and copper. In certain embodiments, the aluminum alloy comprises more than about 1 wt. % of copper, more than about 2 wt. % of copper, more than about 3 wt. % of copper, more than about 4 wt. % of copper, more than about 5 wt. % of copper, more than 6 wt. % of copper, or more than 7 wt. % of copper, based on the total weight of the aluminum alloy. In some embodiments, the aluminum alloy is substantially free of copper.

In further embodiments, the aluminum alloy is an alloy comprising aluminum and magnesium. In certain embodiments, the aluminum alloy comprises more than about 1 wt. % of magnesium, more than about 2 wt. % of magnesium, more than about 3 wt. % of magnesium, more than about 4 wt. % of magnesium, more than about 5 wt. % of magnesium, more than 6 wt. % of magnesium, or more than 7 wt. % of magnesium, based on the total weight of the aluminum alloy. In some embodiments, the aluminum alloy is substantially free of magnesium.

In further embodiments, the aluminum alloy is an alloy comprising aluminum and manganese. In certain embodiments, the aluminum alloy comprises more than about 1 wt. % of manganese, more than about 2 wt. % of manganese, more than about 3 wt. % of manganese, more than about 4 wt. % of manganese, more than about 5 wt. % of manganese, more than 6 wt. % of manganese, or more than 7 wt. % of manganese, based on the total weight of the aluminum alloy. In some embodiments, the aluminum alloy is substantially free of manganese.

In further embodiments, the aluminum alloy is an alloy comprising aluminum and silicon. In certain embodiments, the aluminum alloy comprises more than about 1 wt. % of silicon, more than about 2 wt. % of silicon, more than about 3 wt. % of silicon, more than about 4 wt. % of silicon, more than about 5 wt. % of silicon, more than 6 wt. % of silicon, or more than 7 wt. % of silicon, based on the total weight of the aluminum alloy. In some embodiments, the aluminum alloy is substantially free of silicon.

In further embodiments, the aluminum alloy is an alloy comprising aluminum and zinc. In certain embodiments, the aluminum alloy comprises more than about 1 wt. % of zinc, more than about 2 wt. % of zinc, more than about 3 wt. % of zinc, more than about 4 wt. % of zinc, more than about 5 wt. % of zinc, more than 6 wt. % of zinc, or more than 7 wt. % of zinc, based on the total weight of the aluminum alloy. In some embodiments, the aluminum alloy is substantially free of zinc.

In further embodiments, the aluminum alloy is an alloy comprising aluminum and tin. In certain embodiments, the aluminum alloy comprises more than about 1 wt. % of tin, more than about 2 wt. % of tin, more than about 3 wt. % of tin, more than about 4 wt. % of tin, more than about 5 wt. % of tin, more than 6 wt. % of tin, or more than 7 wt. % of tin, based on the total weight of the aluminum alloy. In some embodiments, the aluminum alloy is substantially free of tin.

In certain embodiments, the aluminum alloys suitable for forming the oxide layer disclosed herein are wrought aluminum alloys. Generally, wrought aluminum can be identified with a four digit number which identifies the alloying elements, followed by a dash, a letter identifying the type of heat treatment and a 1 to 4 digit number identifying the specific temper, e.g. 6061-T6, a common free-machining aluminum alloy. The physical properties of the aluminum alloys can be influenced by the heat treatment and the specific temper.

Some non-limiting examples of suitable wrought aluminum alloys and their compositions are shown in Table 1 below.

TABLE 1
Wrought Aluminum Alloy Composition Limits (in wt. %)

| Alloy | Si | Fe | Cu | Mn | Mg | Cr | Zn | V |
|---|---|---|---|---|---|---|---|---|
| 1060 | 0.25 | 0.35 | 0.05 | 0.03 | 0.03 | 0.03 | 0.05 | 0.05 |
| 1100 | 0.95 Si + Fe | | 0.05–0.20 | 0.05 | | | 0.10 | |
| 2014 | 0.50–1.2 | 0.7 | 3.9–5.0 | 0.40–1.2 | 0.20–0.8 | 0.10 | 0.25 | |
| 2024 | 0.50 | 0.50 | 3.8–4.9 | 0.30–0.9 | 1.2–1.8 | 0.10 | 0.25 | |
| 2219 | 0.20 | 0.30 | 5.8–6.8 | 0.20–0.40 | 0.02 | | 0.10 | 0.05–0.15 |
| 3003 | 0.6 | 0.7 | 0.05–0.20 | 1.0–1.5 | | | 0.10 | |
| 3004 | 0.30 | 0.7 | 0.25 | 1.0–1.5 | 0.8–1.3 | | 0.25 | |
| 3102 | 0.40 | 0.7 | 0.10 | 0.05–0.40 | | | 0.30 | |
| 5052 | 0.25 | 0.40 | 0.10 | 0.10 | 2.2–2.8 | 0.15–0.35 | 0.10 | |
| 5083 | 0.40 | 0.40 | 0.10 | 0.40–1.0 | 4.0–4.9 | 0.05–0.25 | 0.25 | |
| 5086 | 0.40 | 0.50 | 0.10 | 0.20–0.7 | 3.5–4.5 | 0.05–0.25 | 0.25 | |
| 5154 | 0.25 | 0.40 | 0.10 | 0.10 | 3.1–3.9 | 0.15–0.35 | 0.20 | |
| 5454 | 0.25 | 0.40 | 0.10 | 0.50–1.0 | 2.4–3.0 | 0.05–0.20 | 0.25 | |
| 5456 | 0.25 | 0.40 | 0.10 | 0.50–1.0 | 4.7–5.5 | 0.05–0.20 | 0.25 | |
| 6005 | 0.6–0.9 | 0.35 | 0.10 | 0.10 | 0.40–0.6 | 0.10 | 0.10 | |
| 6005A | 0.50–0.9 | 0.35 | 0.30 | 0.50 | 0.40–0.7 | 0.30 | 0.20 | |
| 6060 | 0.30–0.6 | 0.10–0.30 | 0.10 | 0.10 | 0.35–0.6 | 0.5 | 0.15 | |
| 6061 | 0.40–0.8 | 0.7 | 0.15–0.40 | 0.15 | 0.8–1.2 | 0.04–0.35 | 0.25 | |
| 6063 | 0.20–0.6 | 0.35 | 0.10 | 0.10 | 0.45–0.9 | 0.10 | 0.10 | |
| 6066 | 0.9–1.8 | 0.50 | 0.7–1.2 | 0.6–1.1 | 0.8–1.4 | 0.40 | 0.25 | |
| 6070 | 1.0–1.7 | 0.50 | 0.15–0.40 | 0.40–1.0 | 0.50–1.2 | 0.10 | 0.25 | |
| 6105 | 0.6–1.0 | 0.35 | 0.10 | 0.10 | 0.45–0.8 | 0.10 | 0.10 | |
| 6162 | 0.40–0.8 | 0.50 | 0.20 | 0.10 | 0.7–1.1 | 0.10 | 0.25 | |
| 6262 | 0.40–0.8 | 0.7 | 0.15–0.40 | 0.15 | 0.8–1.2 | 0.04–0.14 | 0.25 | |
| 6351 | 0.7–1.3 | 0.50 | 0.10 | 0.40–0.8 | 0.40–0.8 | | 0.20 | |
| 6463 | 0.20–0.6 | 0.15 | 0.20 | 0.05 | 0.45–0.9 | | 0.05 | |
| 7005 | 0.35 | 0.40 | 0.10 | 0.20–0.7 | 1.0–1.8 | 0.06–0.20 | 4.0–5.0 | |
| 7072 | 0.7 Si + Fe | | 0.10 | 0.10 | 0.10 | | 0.8–1.3 | |
| 7075 | 0.40 | 0.50 | 1.2–2.0 | 0.30 | 2.1–2.9 | 0.18–0.28 | 5.1–6.1 | |
| 7116 | 0.15 | 0.30 | 0.50–1.1 | 0.05 | 0.8–1.4 | | 4.2–5.2 | 0.05 |
| 7129 | 0.15 | 0.30 | 0.50–0.9 | 0.10 | 1.3–2.0 | 0.10 | 4.2–5.2 | 0.05 |
| 7178 | 0.40 | 0.50 | 1.6–2.4 | 0.30 | 2.4–3.1 | 0.18–0.28 | 6.3–7.3 | |

| | | | | | | Other | | |
|---|---|---|---|---|---|---|---|---|
| Alloy | Ti | Bi | Ga | Pb | Zr | each | total | Al |
| 1060 | 0.03 | 0.03 | 0.03 | 0.03 | 0.03 | 0.03 | | 99.6 min |
| 1100 | | | | | | 0.05 | 0.15 | 99.0 min |
| 2014 | 0.15 | | | | | 0.05 | 0.15 | remainder |
| 2024 | 0.15 | | | | | 0.05 | 0.15 | remainder |
| 2219 | 0.02–0.10 | | | | 0.10–0.25 | 0.05 | 0.15 | remainder |
| 3003 | | | | | | 0.05 | 0.15 | remainder |
| 3004 | | | | | | 0.05 | 0.15 | remainder |
| 3102 | 0.10 | | | | | 0.05 | 0.15 | remainder |
| 5052 | | | | | | 0.05 | 0.15 | remainder |
| 5083 | 0.15 | | | | | 0.05 | 0.15 | remainder |
| 5086 | 0.15 | | | | | 0.05 | 0.15 | remainder |
| 5154 | 0.20 | | | | | 0.05 | 0.15 | remainder |
| 5454 | 0.20 | | | | | 0.05 | 0.15 | remainder |
| 5456 | 0.20 | | | | | 0.05 | 0.15 | remainder |
| 6005 | 0.10 | | | | | 0.05 | 0.15 | remainder |
| 6005A | 0.10 | | | | | 0.05 | 0.15 | remainder |
| 6060 | 0.10 | | | | | 0.05 | 0.15 | remainder |
| 6061 | 0.15 | | | | | 0.05 | 0.15 | remainder |
| 6063 | 0.10 | | | | | 0.05 | 0.15 | remainder |
| 6066 | 0.20 | | | | | 0.05 | 0.15 | remainder |
| 6070 | 0.15 | | | | | 0.05 | 0.15 | remainder |
| 6105 | 0.10 | | | | | 0.05 | 0.15 | remainder |
| 6162 | 0.10 | | | | | 0.05 | 0.15 | remainder |
| 6262 | 0.15 | 0.40–0.7 | | 0.40–0.7 | | 0.05 | 0.15 | remainder |
| 6351 | 0.20 | | | | | 0.05 | 0.15 | remainder |
| 6463 | | | | | | 0.05 | 0.15 | remainder |
| 7005 | 0.01–0.06 | | | | 0.08–0.20 | 0.05 | 0.15 | remainder |
| 7072 | | | | | | 0.05 | 0.15 | remainder |
| 7075 | 0.20 | | | | | 0.05 | 0.15 | remainder |
| 7116 | 0.05 | | 0.03 | | | 0.05 | 0.15 | remainder |
| 7129 | 0.05 | | 0.03 | | | 0.05 | 0.15 | remainder |
| 7178 | 0.20 | | | | | 0.05 | 0.15 | remainder |

Any wrought aluminum alloy known to a skilled artisan may be suitable for forming the oxide layer disclosed herein. In some embodiments, the aluminum alloy can be one of the 2000 series, 3000 series, 4000 series, 5000 series, 6000 series, or 7000 series alloys. In general, the major non-aluminum alloying constituents are copper, manganese, silicon, magnesium, magnesium/silicon, and zinc for the 1000 series, 2000 series, 3000 series, 4000 series, 5000 series, 6000 series, or 7000 series aluminum alloys respectively. Some non-limiting examples of suitable wrought aluminum alloys include those alloys listed in Table I above as well as 2011, 2017, 4032, 5005, 6061, and the like.

In other embodiments, each of the 1000 series, 2000 series, 3000 series, 4000 series, 5000 series, 6000 series, or 7000 series aluminum alloys can be heat treated and therefore, have one of the F, O T or H temper code designations as described below.

The designation “F” means that the alloys are as fabricated, i.e., no special control, such as casting, hot working, or cold working, has been performed to the heat treatment or strain hardening after the shaping process.

The designation “O” means that the alloys have been annealed. This is the lowest strength, highest ductility temper

The designation “T” means that the alloys have been strengthened by heat treatment, with or without subsequent strain hardening. The T temper codes are shown below.

T1 Cooled from an elevated temperature shaping process and naturally aged to a substantially stable condition.

T2 Cooled from an elevated temperature shaping process, cold worked, and naturally aged to a substantially stable condition.

T3 Solution heat treated, cold worked, and naturally aged to a substantially stable condition.

T4 Solution heat treated, and naturally aged to a substantially stable condition.

T5 Cooled from an elevated temperature shaping process then artificially aged.

T6 Solution heat treated then artificially aged.

T7 Solution heat treated and then overaged/stabilized.

T8 Solution heat treated, cold worked, then artificially aged.

T9 Solution heat treated, artificially aged, then cold worked.

T10 Cooled from an elevated temperature shaping process, cold worked, then artificially aged.

The designation “H” means that the alloys have been strengthened by strain hardening, with or without subsequent heat treatment. The H temper strain hardening codes are shown below.

H1 Strain hardened only.

H2 Strain hardened and partially annealed.

H3 Strain hardened and stabilized.

H4 Strain hardened and lacquered or painted. This assumes that thermal effects from the coating process affect the strain hardening; not encountered often.

In certain embodiments, the aluminum alloys suitable for forming the oxide layer disclosed herein are cast aluminum alloys. Generally, cast aluminum alloys can be identified by a four to five digit number with a decimal point. The digit in the hundred's place indicates the alloying elements, while the digit after the decimal point indicates the form (cast shape or ingot). For example, cast alloys include the x1xx.x series which comprises at least 99% aluminum; the x2xx.x series which comprises copper; the x3xx.x series which comprises silicon, copper and/or magnesium; the x4xx.x series which comprises silicon; the x5xx.x series which comprises magnesium; the x7xx.x series which comprises zinc; the x8xx.x series which comprises tin; and the x9xx.x series which comprises miscellaneous metals. Some non-limiting examples of suitable wrought aluminum alloys include 355, 356, 357, 360, 380, 319 and the like.

In some embodiments, the aluminum alloys suitable for forming the oxide layer disclosed herein are named aluminum alloys. Some non-limiting examples of named aluminum alloys include Al—Li alloys (an alloy of aluminum and lithium), Duralumin (an alloy of aluminum and copper), Nambe (an alloy of aluminum plus seven other undisclosed metals), Magnox (an alloy of aluminum and magnesium), Zamak (an alloy of aluminum, zinc, magnesium and copper), Silumin (an alloy of aluminum and silicon), and AA-8000.

The anodizing method disclosed herein generally comprises at least three processing steps, i.e., pre-treatment, anodizing and post-treatment. Any pretreatment process known to a skilled artisan can be used to pre-treat the surfaces of the aluminum materials before the anodizing step. Some non-limiting examples of suitable pre-treatment processes include cleaning the surfaces by mechanical and/or chemical means, treating the surfaces by corona discharge, flame, plasma, alkaline, and/or acid etching, and combinations thereof. In some embodiments, the surfaces of the aluminum materials can be first cleaned and then chemically treated or etched. The cleaning can be done by any known mechanical means, chemical means or a combination thereof. One non-limiting example of cleaning includes using a solvent in a degreasing process using mechanical stirring or ultrasonic vibration to remove oils and particulates on the surfaces.

Optionally, the cleaned surfaces subsequently can be chemically treated with a non-etch alkaline solution to further remove contamination, preferably at an elevated temperature. Alternatively, the cleaned surfaces can be etched by an aqueous solution of an inorganic acid, a strong organic acid or a combination thereof. Some non-limiting examples of suitable inorganic acid include sulfuric acid, nitric acid, hydrochloric acid, hydrofluoric acid, hydrobromic acid, hydroiodic acid, phosphoric acid and combinations thereof. Some non-limiting examples of suitable strong organic acids include p-toluenesulfonic acid, trifluoroacetic acid, 4-(trifluoromethyl)benzoic acid, methanesulfonic acid, acetic acid and combinations thereof. The etching acid solution may further comprise an oxidant such as metal dichromates (e.g., lithium, sodium and potassium dichromate) or metal permanganates (e.g., lithium, sodium and potassium permanganate), peroxides (e.g., hydrogen peroxide) and combinations thereof.

Generally, various degrees of etching (i.e. light, medium, heavy) can be controlled by varying the time and temperature of the etching process. The time of etching may vary from about 1 minute to about 4 hours, from about 10 minutes to about 2 hours, or from about 15 minutes to about 1 hour. The temperature of etching may range from about 20° C. to about 90° C., from about 25° C. to about 80° C., from about 30° C. to about 75° C., or from about 30° C. to about 60° C. The degree of etching can generally be increased by increasing the time of etching, the temperature of etching or a combination thereof.

In some embodiments, the surfaces of the aluminum materials are pre-treated by the Forest Product Laboratories (FPL) etch process. The FPL etch process generally comprises the following steps:

1) the degreasing step in which oils and particulates are removed using a solvent such as hydrocarbons and halogenated hydrocarbons (e.g., trichloroethylene);

2) the alkaline cleaning step in which the aluminum materials are immersed in a non-etch alkaline solution to further remove contamination at about 50° F. to about 140° F.;

3) the etching step in which the aluminum materials are immersed in an aqueous solution of sulfuric acid and sodium dichromate for about 9-15 minutes;

4) the rinse step in which the aluminum materials are rinsed with water for about 1 to 2 minutes at no greater than 50° C.; and

5) the drying step in which the aluminum materials are air dried for one hour at less than 65° C.

In other embodiments, the surfaces of the aluminum materials are pretreated by the phosphoric acid anodize (PAA) etch process. The PAA etch process generally is similar to the FPL etch process except that the PAA etch process further comprises an anodizing process in which a bias of about 10V is applied across a stainless steel cathode to generate a superficial anodic layer on the workpiece.

Optionally, the surfaces of the aluminum materials can be brightened by pre-treating the surfaces with a concentrated mixture of phosphoric and nitric acids which chemically smoothes the aluminums surface. In some embodiments, a near mirror finish can be created.

In the anodizing step, the aluminum material is immersed in a bath containing an electrolyte while an electrical current is passed through the bath to develop an oxide layer on the surfaces of the aluminum materials. The oxide layer is mainly derived from the aluminum material itself, not from the electrolyte. Depending on the aluminum materials, the oxide layer can be transparent, opaque or colored. Further, the oxide layer can be simultaneously or subsequently dyed to one or more desirable colors suitable for various decorative and/or protective applications.

The aqueous electrolyte generally comprises water, sulfuric acid and oxalic acid. Any commercially available sulfuric acid can be used. The amount of sulfuric acid may be from about 100 g to about 360 g, from about 140 g to about 220 g, or from about 160 g to about 200 g per liter of the electrolyte. Any commercially available oxalic acid can be used. The amount of oxalic acid may be from about 5 g to about 40 g, from about 12 g to about 20 g, or from about 14 g to about 18 g per liter of the electrolyte. In some embodiments, the electrolyte comprises sulfuric acid in an amount from about 160 g to about 200 g per liter of the electrolyte and oxalic acid in an amount from about 14 g to about 18 g per liter of the electrolyte.

Optionally, the electrolyte may further comprise aluminum ions, a metal sulfate, an organic acid other than oxalic acid, a metal carboxylate or a combination thereof. In some embodiments, the electrolyte comprises aluminum ions. The amount of aluminum ions may be from about 0.5 g to about 30 g, from about 1 g to about 20 g, or from about 2 g to about 11 g per liter of the electrolyte. In other embodiments, the electrolyte comprises a metal sulfate, an organic acid other than oxalic acid or a metal salt of an organic acid. The amount of each of the metal sulfate, organic acid and metal carboxylate can be from 0 to about 100 g per liter of the electrolyte. In certain embodiments, the electrolyte is substantially free of a metal sulfate, an organic acid other than oxalic acid, or a metal carboxylate.

Some non-limiting examples of metal sulfates include sulfates of lithium, sodium, potassium, copper, magnesium, manganese, silicon, zinc, iron, chromium, vanadium, titanium, bismuth, gallium, tin, lead, zirconium, nickel, cobalt or a combination thereof. Some non-limiting examples of suitable organic acids include saturated aliphatic alpha-hydroxy monocarboxylic acids (e.g., glycolic acid, lactic acid, and malic acid) and saturated and unsaturated aliphatic dicarboxylic acids other than oxalic acid (e.g., malonic, succinic, and maleic acid). The metal of the metal carboxylate may be lithium, sodium, potassium, copper, magnesium, manganese, silicon, zinc, iron, chromium, vanadium, titanium, bismuth, gallium, tin, lead, zirconium, nickel or cobalt. The carboxylate can be derived from a saturated aliphatic monocarboxylic acid, saturated aliphatic alpha-hydroxy monocarboxylic acid and saturated and unsaturated aliphatic dicarboxylic acid including oxalic acid, or a combination thereof.

The temperature of the anodizing bath may be from about 5° C. to about 25° C. or from about 10° C. to about 15° C. The anodizing step can be operated at a first current density of less than 0.8 A/dm², less than 0.7 A/dm², less than 0.6 A/dm², or less than 0.5 A/dm² for a first time period and then a second current density from about 1.5 A/dm² to about 2.5 A/dm², from about 1.6 A/dm² to about 2.4 A/dm², or from about 1.7 A/dm² to about 2.3 A/dm² for a second time period. The first time period may be from 0 to about 10 hours, from about 0.5 minutes to about 5 hours, or from about 1 minute to about 1 hour. The second time period may be from about 1 minute to about 5 hours, from about 5 minute to about 1.5 hours, or from about 5 minute to about 45 minutes. The anodizing step may further comprising using a third current density from about 0.5 A/dm² to about 2.0 A/dm², from about 0.75 A/dm² to about 1.75 A/dm², or from about 1.0 A/dm² to about 1.5 A/dm² for a third time period. The third time period may be from about 1 minute to about 5 hours, from about 1 minute to about 2 hours, or from about 1 minute to about 30 minutes.

To maintain the current density in a specified range, it may be necessary to increase gradually the applied voltage across the electrodes from about 10 volts to about 250 volts with time, depending on the thickness of the oxide layer developed on the aluminum material. In some embodiments, the applied voltage is increased from about 10 volts to about 200 volts, from about 15 volts to about 150 volts, or from about 20 volts to about 100 volts to keep the current density constant or in a specific range. The anodizing step disclosed herein may use a constant direct current, pulsed direct current, rectified pulsed direct current, alternative current, rectified alternative current or a combination thereof.

Optionally, the electrolyte can be agitated or cooled by any agitation or cooling device that can take out the heat generated on the surface of the aluminum material during the anodizing step. An effective control of the temperature of electrolyte generally can stabilize the coating quality and enhance coating physical properties. In some embodiments, the agitation device is a mechanical mixing device, such as stirrers, mixers and homogenizers, or an ultrasonic vibrator or mixer that can facilitate the circulation of the electrolyte around the surface of the aluminum material.

In other embodiments, the agitation device comprises one or more agitation tubes having holes with a diameter from about 5 microns to about 50 microns, from about 10 microns to about 40 microns, or from about 15 microns to about 25 microns. Air can be forced to pass through the holes to generate very fine air bubbles near or on the surface of the aluminum material. The air bubbles can transfer the thermal energy generated on the surface of the aluminum material to the relatively cooler electrolyte.

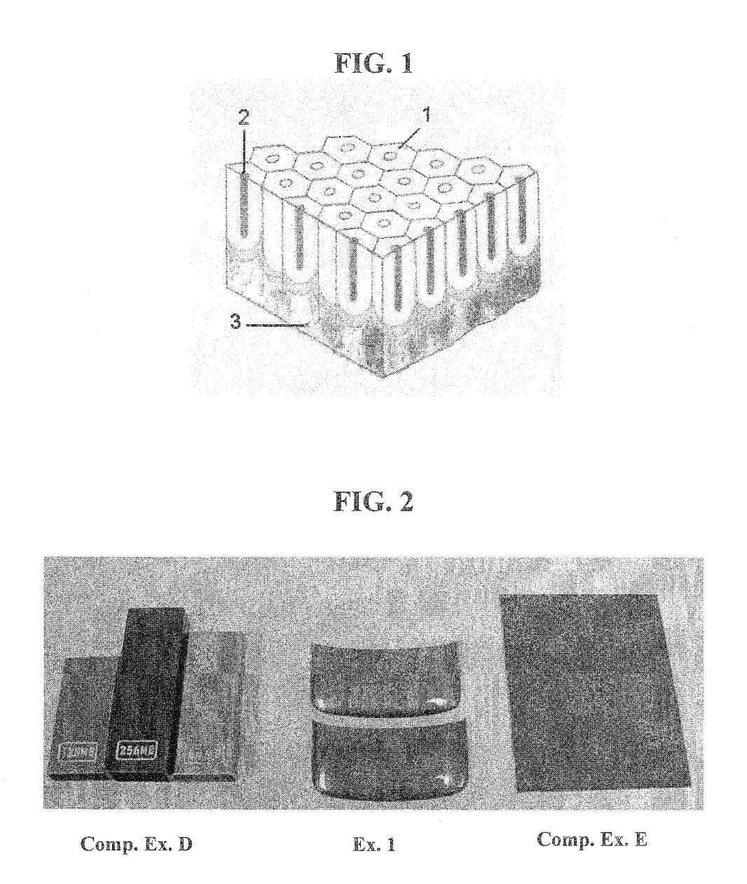

In the post treatment step, the porous anodic oxide layer can be dyed or colored, sealed, polished, or a combination thereof. In some embodiments, the oxide layer can be dyed before sealing to form a dye layer thereon. Any organic and inorganic dye or colorant suitable for dyeing or coloring anodic oxide layers can be used herein. FIG. 1 shows the pores (2) of anodic cells (1) of an anodic oxide layer on an aluminum substrate (3). In some embodiments, the diameter of the pores is from 0.005 to about 0.05 microns, or from 0.01 to about 0.03 microns. In other embodiments, the particle size of the dye or colorant molecule is from about 5 nm to about 60 nm, or from about 15 nm to about 30 nm. The dying or coloring can be carried out by any dying or coloring method known to a skilled artisan that can cause a dye or color to enter or deposit in the pores of the anodic cells to form a dye layer.

Some organic and inorganic dyes are disclosed in the literature, for example, in S. Kawai, “Anodizing and Coloring of Aluminum Alloys,” ASM International (2002), which is incorporated herein by reference. Some non-limiting examples of organic dyes include acid dyes, acid metal complexes dyes, acid medium dyes, direct dyes, weak acid dyes, disperse dyes, dissolved reductive dyes, active dyes, alkaline dyes, and solvent dyes such as alcohol soluble dyes and oil soluble dyes. Some non-limiting examples of inorganic dyes are listed in Table 2 below. The colors obtainable from the inorganic dyes are also listed in Table 2.

| Color Obtainable | Name of some inorganic dyes |
|---|---|
| red brown | CuSO₄•5H₂O |
| | [Fe(CN)₆]K₄ |
| brown | CuSO₄•5H₂O |
| | [Fe(CN)₆]K₃ |
| | HOCH₂CH₂NH₂ |
| | NiCl₂ |
| | AgNO₃ |
| | K₂Cr₂O₇ |
| dark brown | CoAc₂ |
| | NH₂CH₂CH₂NH₂•H₂O |
| | NiSO₄ |
| | NH₂CH₂CH₂NH₂•H₂O |
| | PbAc₂ |
| | (NH₄)₂S |
| | Co(NO₃)₂ |
| | H₂O₂ |
| | NH₄OH |
| yellow | PbAc₂ |
| | K₂Cr₂O₇ |
| | PbAc₂ |
| | K₂CrO₄ |
| | CdAc₂ |
| | (NH₄)₂S |
| white | PbAc₂ |
| | Na₂SO₄ |
| | Ba(NO₃)₂ |
| | Na₂SO₄ |
| black | CoAc₂ |
| | Na₂S |
| | CoAc₂ |
| | KMnO₄ |
| blue | [Fe(CN]₆]K₄ |
| | Fe₂(SO₄)₃ |
| | [Fe(CN]₆]K₄ |
| | FeCl₃ |
| chryso | Na₂S₂O₃ |
| | KMnO₄ |
| orange yellow | K₂CrO₄ |
| | AgNO₃ |
| | CuAc₂ |
| | 2-Aminopropane |
| | CuAc₂ |
| | NH₂CH₂CH₂NH₂•H₂O |
| Golden-yellow | Zn(CrO₄)₂ |
| | ZnF₂ |
| | HNO₃ |
| | FeAc₃ |
| | NH₃ |
| Olive Drab | FeSO₄ |
| | NH₂CH₂CH₂NH₂•H₂O |
| bronze | CoAc₂ |
| | KMnO₄ |
| chryso(light) | (NH₄)₃Fe(C₂O₄)₃ |
| chryso(dark) | (NH4)3Fe(C2O4)3•3H2O |

Generally, dyeing or coloring can be achieved in one of the following ways. In electrolytic coloring, after anodizing, the workpiece can be immersed in an electrolyte bath comprising an inorganic metal salt. Then a current can be applied which deposits the metal salt in the base of the pores of the anodic cells. The resulting color generally depends on the metal used and the processing conditions Further, the range of colors can be expanded by overdyeing with organic dyes. Some non-limiting examples of suitable metals include tin, cobalt, nickel, and copper.

Integral coloring combines anodizing and coloring to simultaneously form and color the oxide cell wall in different colors and shapes such as bronze and black shades. In general, integral coloring is more abrasive resistant than conventional anodizing. It may be one of the most expensive processes since it requires significantly more electrical power.

Organic dyeing can be used to produce a wide variety of colors. Organic dyes offer vibrant colors with intensities that may not be matched by any other paint system in the market. Generally, they can provide excellent weather-fastness and light-fastness. The color range can be broadened by over-dyeing the electrolytic colors with the organic dyes for a wider variety of colors and shades. This method is relatively inexpensive and involves the least amount of initial capital of any other coloring process.

Interference coloring involves the modification of the pore structure produced in electrolytes comprising sulfuric acid. Pore enlargement can occur at the bases of the pores. Metal deposition at these locations can produce numerous light-fast colors ranging from blue, green and yellow to red. The colors are generally caused by optical-interference effects, rather than by light scattering as with the basic electrolytic coloring process.

In some embodiments, organic dyes are used to fill the pores in the anodic oxide layer with color. In other embodiments, inorganic dyes or metal salts are electrochemically deposited at the base of the pores to create a broad spectrum of colors. In further embodiments, a metal (e.g., tin) can be electrolytically deposited in the pores of the anodic oxide layer to provide colors. In certain embodiments, the color may be produced integral to or within the anodic oxide layer by adding certain organic acids to the sulfuric electrolyte and using a pulsed current during the anodizing process. Some non-limiting examples of the oxide layer colors include red, orange, yellow, green, blue, indigo, purple, pink, silver, gold, bronze, brown, black, gray, pale champagne, white, and all known shades and tints thereof.

After dyeing, the surface of the oxide layer can be optionally sealed by any method known to a skilled artisan for sealing anodic oxide layers. Generally, sealing closes the pores in the anodic cells and thus may provide a surface resistant to staining, abrasion, crazing and color degradation. Further, sealing may reduce or eliminate dye bleed out and can increase corrosion resistance. In some embodiments, the sealing is carried out at 20° C. in a salt, such as nickel salts, cobalt salts and combinations thereof, by impregnating and thus closing the pores with the salts. In other embodiments, the sealing is carried out by using hot water or steam to convert the oxide into its hydrated form. This conversion reduces the size of the pores of the anodic cells and thus the porosity of the surface as the oxide swells. In further embodiments, the sealing occurs in the presence of a metal dichromate such as sodium dichromate. In further embodiments, the sealing occurs in the presence of a metal acetate such as nickel acetate or other anti-bloom agents.

After sealing, the surface of the oxide layer can be optionally polished or buffed by any polishing or buffing method known to a skilled artisan. In some embodiments, the surface of the oxide layer is buffed or polished by a buffing or polish compound. The buffing or polish compound generally comprises abrasive particles, a binder and optional additives. The buffing or polish compound may further comprise diluent particles such as marble, gypsum, flint, silica, iron oxide, aluminum silicate, and glass (including glass bubbles and glass beads). The buffing or polish compound can be in the form of a cake, tube, paste, or liquid. Some non-limiting examples of polishing compound or buffing compounds include Opaline polishing compound from Rhone-Poulenc Co., France, and tripoli compounds from Formax Manufacturing Corp., Grand Rapids, Mich.

Any conventional abrasive particle known in the art can be used for the buffing or polish compound. Some non-limiting examples of suitable abrasive particles include particles of fused aluminum oxide (including white fused alumina, heat-treated aluminum oxide and brown aluminum oxide), silicon carbide (including green silicon carbide), boron carbide, titanium carbide, diamond, cubic boron nitride, garnet, tripoli (microcrystalline SiO₂), chromium oxide, cerium oxide, fused alumina-zirconia, sol-gel-derived abrasive particles, and combinations thereof. Any conventional buffing compound binder known in the art can be used for the buffing or polish compound. Some non-limiting examples of suitable binders include natural waxes, synthetic waxes, chlorinated waxes, such as tetrachloronaphtalene, pentachloronaphthalene, and polyvinyl chloride, and combinations thereof.

Any conventional abrasive additive known in the art can be used for the buffing or polish compound. Some non-limiting examples of suitable additives include pigments such as titanium dioxide or iron oxide, emulsifiers, surfactants, wetting agents, foam stabilizers, thermal or UV stabilizers, antioxidants, grinding aids and combinations thereof. Examples of grinding aids include organic halide compounds, halide salts, such as sodium chloride, potassium cryolite, sodium cryolite, ammonium cryolite, potassium tetrafluoroborate, sodium tetrafluoroborate, silicon fluorides, potassium chloride, and magnesium chloride.

In some embodiments, buffing can be carried out with a revolving buffing wheel charged with a buffing compound in contact with the surface of the workpiece. In other embodiments, buffing can done in two steps, i.e., cutting down and coloring. The cutting down step is the preliminary step performed with a coarse cutting abrasive buffing compound. In some instances, the cutting down step may be all that is necessary to secure a desirable surface finish or smoothness. The coloring step generally involves a light-duty buffing intended to bring up a luster on the surfaces of the workpiece. Optionally, coloring compounds can be used. Some coloring compounds are formulated with finer mesh size abrasives than those used in the buffing compounds for the cutting step. In some embodiments, same double-duty buffing compound can be used in both the cutting and coloring steps.

In some embodiments, the buffing compound is in the form of a liquid or a paste. The abrasive particles and binders used in formulating liquid or paste buffing compounds are generally the same as those used in solid buffing compounds. The ingredients in the liquid or paste buffing compounds are carried in a water-based and emulsified fluid intended for spray or brush application.

In certain embodiments, the buffing is done with buffing wheels. Buffing wheels generally serve two main functions. The first is to carry the abrasive particles across the surfaces of the workpiece to perform a cutting and/or coloring action. The second is, where required, to generate sufficient frictional heat to permit plastically flowing or burnishing the work surface. Buffing wheels suitable for the polishing or buffing processes disclosed herein can be in a range of designs, buffing fabrics and constructions known to a skilled artisan.

In other embodiments, the surface of the oxide layer is polished by an abrasive slurry, abrasive compound or abrasive article, such as a fine abrasive wheel or an abrasive paper, known to a skilled artisan. In some embodiments, the surface of the oxide layer is polished or buffed by known conventional micro-finishing products such as lapping films. In some embodiments, the lapping films comprises abrasive articles with a size of 400 grits or finer. In some embodiments, the surface of the oxide layer has an Ra value of less than about 0.1 microns, less than about 0.09 microns, less than about 0.08 microns, less than about 0.07 microns, less than about 0.06 microns, less than about 0.05 microns, less than about 0.04 microns, less than about 0.03 microns, less than about 0.02 microns, or less than about 0.01 microns. The surface smoothness can be measured by the following profilometry method.

The surface roughness of the oxide layer can be measured by a Talysurf PGI 1240 Aspherics Measuring System from Taylor Hobson, Leicester, England. The gauge distance can be about 10 mm, about 5 mm, about 1 mm, about 0.5 mm, about 0.25 mm or about 0.1 μm in a straight line. The probe speed for the measurements can be about 5 mm/s, about 1 mm/s, about 0.5 mm/s, about 0.25 mm/s or about 0.1 mm/s.

In some embodiments, the oxide layer has a microhardness value from about 280 Hv to about 1000 Hv, from about 280 Hv to about 750 Hv, from about 300 Hv to about 550 Hv, from about 320 Hv to about 520 Hv or from about 320 Hv to about 500 Hv, as measured by the method disclosed herein. In one embodiment, the microhardness can be measured by a Buehler Micromet 2103 having a Vickers diameter (square base) indenter with a 136 degree angle. In another embodiment, the microhardness can be measured by any conventional microhardness measurement method known to a skilled artisan

In some embodiments, the oxide layer has a thickness from about 15 microns to about 100 microns, from about 15 microns to about 75 microns, from about 15 microns to about 50 microns, from about 15 microns to about 40 microns or from about 15 microns to about 30 microns. In one embodiment, the thickness is measured by a Fischer Isoscope MP30E Coating thickness tester.

The method disclosed herein can be used for batch anodizing and continuous coil anodizing. Batch anodizing generally involves racking parts and immersing them in a series of treatment tanks. Non-limiting examples of parts suitable for batch anodizing include extrusions, sheets or bent metal parts, castings, cookware, cosmetic cases, flashlight bodies, and machined aluminum parts.

Continuous Coil Anodizing generally involves continuously unwinding of pre-rolled coils through a series of anodizing, etching and cleaning tanks, and then rewinding the anodized coils for shipment and fabrication. This method can be used for high volume sheet, foil and less severely formed products such as lighting fixtures, reflectors, louvers, spacer bars for insulated glass, and continuous roofing systems.

### EXAMPLES

The following examples are intended for illustrative purposes only and do not limit in any way the scope of the present invention.

### Example 1

Example 1 was prepared by anodizing an aluminum alloy Al-6063 workpiece in an electrolyte bath comprising water, sulfuric acid (180 g/liter of electrolyte) and oxalic acid (16 g/liter of electrolyte) at a temperature from about 10° C. to about 16° C. The anodizing process were done in four sequential steps, each of which involved a different current density and electrolysis time. The current density of the first step was from 0 to about 0.7 A/dm² for 10 minutes. The current density of the second step was from 0.7 A/dm² to about 2.0 A/dm² for 10 minutes. The current density of the third step was from 2.0 A/dm² to about 2.5 A/dm² for 10 minutes. The current density of the fourth step was from 1.5 A/dm² to about 2.5 A/dm² for 50 minutes. The current densities were generated by a pulse type DC having a voltage potential from about 20 V to about 24 V. The sequence of the first, second and third pulse currents was 0.8 seconds on and then 0.2 seconds off. The sequence of the fourth pulse current was 0.6 seconds on and then 0.4 seconds off.

### Example 2

Example 2 was prepared similarly according to the procedure for Example 2 except that the workpiece was dyed with a blue color.

### Example 3

Example 3 was prepared similarly according to the procedure for Example 2 except that the workpiece was dyed with a red color

### Comparative Example A

Comparative Example A was prepared by anodizing an aluminum alloy Al-6063 workpiece in an electrolyte bath comprising water and sulfuric acid (180-200 g/liter of electrolyte) at about 24° C. with a direct current at about 12-22 V and a current density of about 1.0 A/dm² for 15 minutes.

### Comparative Example B

Comparative Example B was prepared by anodizing an aluminum alloy Al-6063 workpiece in an electrolyte bath comprising water and sulfuric acid (180-200 g/liter of electrolyte) at a about 24° C. with a direct current at about 12-22 V and a current density of 1.0 A/dm² for about 45-60 minutes.

### Comparative Example C

Comparative Example C was prepared by coating an aluminum alloy Al-6063 workpiece with a diamond-like carbon using the physical vapor deposition technique. The process duration was about 2-2.5 hours. The thickness of the diamond-like carbon coating was about 1 micron. The interface was chromium.

### Comparative Example D (Class 2 Anodizing)

Comparative Example D was prepared by anodizing an aluminum alloy Al-6063 workpiece in an electrolyte bath comprising water and sulfuric acid (190-200 g/liter of electrolyte) at a about 18-20° C. with a direct current at about 15-17 V and a current density of 1.5 A/dm² for about 45-60 minutes.

Wear Test

Comparative Examples A-C and Example 1 were tested for their wear resistance. The wear test was done with a Taber Abrasive Wearing Tester according to the ISO5470-1 procedure using a course CS-17 abrasive head at a loading of 1 Kg. The test was run at a speed of 40 rpm with suction on. The thickness of the oxide layer was measure by a Fischer Coating thickness tester. The wear test data are shown in Table 3 below. The data in Table 3 show that Example 1 has a higher wear resistance than Comparative Examples A-C.

TABLE 3
Wear Test Results.

| | Coating thickness remaining | | | |
|---|---|---|---|---|
| No. of Wear Cycles | Comp. Ex. A | Comp. Ex. B | Ex. 1 | Comp. Ex. C |
| 0 | 3 | 14 | 21 | 1 |
| 500 | 2 | | | |
| 1000 | | 13 | | |
| 1500 | 1.5 | | | |
| 3000 | 0 | | | |
| 4000 | | 12 | | |
| 5000 | | | 17 | 0 |
| 10000 | | 5 | 15 | |
| 15000 | | | 12 | |

Coating Microhardness Test

Comparative Example D and Example 1 were measured for their microhardness. The micro-hardness tester was a Buehler Micromet 2103 having a Vickers diameter (square base) indenter with a 136 degree angle. Comparative Example D and Example 1 were cross-cut, plastic mounted and polished before measuring. The load for the microhardness testing was 300 gf for Example 1 and 500 gf for Comparative Example D. The microhardness test data are shown in Tables 4 and 5 below. The data in Tables 4 and 5 show that Example 1 has a higher average microhardness than Comparative Example D.

TABLE 4
The microhardness test results for Example 1

| Testing load (gf) | Micro-hardness (HV) | Remarks |
|---|---|---|
| 300 | 348.5 | Nil |
| 300 | 342.5 | |
| 300 | 346.8 | |
| Average | 345.9 | |

TABLE 5
The microhardness test results for Comparative Example D

| Testing load (gf) | Micro-hardness (HV) | Remarks |
|---|---|---|
| 500 | 267.7 | Coating breaks |
| 500 | 258.8 | Coating breaks |
| 500 | 272.2 | Coating breaks |
| Average | 266.2 | Unpredictable |

The surface roughness of Examples 2 and 3 were measured by a Talysurf PGI 1240 Aspherics Measuring System from Taylor Hobson, Leicester, England. The gauge distance was 0.25 mm. The probe speed for the measurements was 0.5 mm/s. An ISO type filter was used. Each sample was measured in both East to West and South to North directions. The surface roughness data of Examples 2 and 3 are listed in Table 6 below.

TABLE 6

| | Ra in East to | Ra in East to | |
|---|---|---|---|
| Sample | West direction | West direction | Average Ra |
| Ex. 2 | 0.038 μm | 0.040 μm | 0.039 μm |
| Ex. 3 | 0.038 μm | 0.041 μm | 0.040 μm |

As demonstrated above, embodiments of the invention provide various methods of producing a colored oxide layer for decorative applications. While the invention has been described with respect to a limited number of embodiments, the specific features of one embodiment should not be attributed to other embodiments of the invention. No single embodiment is representative of all aspects of the invention. In some embodiments, the methods may include numerous steps not mentioned herein. In other embodiments, the methods do not include, or are substantially free oft steps not enumerated herein. Variations and modifications from the described embodiments exist. It is noted that the methods for producing a colored oxide layer disclosed herein are described with reference to a number of steps. These steps can be practiced in any sequence. One or more steps may be omitted or combined but still achieve substantially the same results. The appended claims intend to cover all such variations and modifications as falling within the scope of the invention.

All publications and patent applications mentioned in this specification are herein incorporated by reference to the same extent as if each individual publication or patent application was specifically and individually indicated to be incorporated by reference. Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

What is claimed is:

1. A method of producing a colored oxide layer on an aluminum material comprising the steps of:
(a) placing the aluminum material as an anode in an electrolyte comprising water, oxalic acid, and sulfuric acid; and
(b) anodizing the aluminum material with a first current having a density of less than 0.8 A/dm² for a time period from about 1 minute to about 1 hour; and then with a second current having a density from about 1.5 A/dm² to about 2.5 A/dm² to produce an oxide layer.

2. The method of claim 1, wherein the aluminum material is further anodized with a third current having a density from 1.0 A/dm² to about 1.5 A/dm².

3. The method of claim 2, wherein each of the first, second and third currents is independently generated by a constant direct current or pulsed direct current.

4. The method of claim 1 further comprising agitating the electrolyte with an agitation device.

5. The method of claim 4, wherein the agitation device comprises agitation tubes.

6. The method of claim 1 further comprising forming a dye layer on the oxide layer.

7. The method of claim 1, wherein the electrolyte further comprises aluminum ion, a metal sulfate, organic acid or a combination thereof.

8. The method of claim 1, wherein the electrolyte further comprises from about 2 g to about 11 g of aluminum ion per liter of the electrolyte.

9. The method of claim 1, wherein the electrolyte comprises from about 5 g to about 40 g of oxalic acid per liter of the electrolyte, and from about 100 g to about 360 g of sulfuric acid per liter of the electrolyte.

10. The method of claim 9, wherein the electrolyte comprises from about 12 g to about 20 g of oxalic acid per liter of the electrolyte, and from about 140 g to about 220 g of sulfuric acid per liter of the electrolyte.

11. The method of claim 10, wherein the electrolyte comprises from about 14 g to about 18 g of oxalic acid per liter of the electrolyte, and from about 160 g to about 200 g of sulfuric acid per liter of the electrolyte.

12. The method of claim 1, wherein the anodizing step is performed at a temperature from about 5° C. to about 25° C.

13. The method of claim 12, wherein the anodizing step is performed at a temperature from about 10° C. to about 15° C.

14. The method of claim 1, wherein the method further comprises a step of buffing the surface of the oxide layer to a Ra value of less than 0.1 microns.

15. An article comprising an aluminum material having a colored oxide layer on the aluminum material, wherein the colored oxide layer is prepared by a method comprising the steps of:
(a) placing the aluminum material as an anode in an electrolyte comprising water, oxalic acid, and sulfuric acid; and
(b) anodizing the aluminum material with a first current having a density of less than 0.8 A/dm² for a time period from about 1 minute to about 1 hour; and then with a second current having a density from about 1.5 A/dm² to about 2.5 A/dm² to produce an oxide layer.

16. The article of claim 15, wherein the colored oxide layer has a microhardness value from about 280 Hv to about 1000 Hv.

17. The article of claim 15, wherein the colored oxide layer has a thickness from about 15 microns to about 50 microns.

18. The article of claim 15, wherein the aluminum material comprises aluminum and optionally an element selected from the group consisting of silicon, boron, germanium, arsenic, antimony, tellurium, copper, magnesium, manganese, zinc, lithium, iron, chromium, vanadium, titanium, bismuth, gallium, tin, lead, zirconium, nickel, cobalt and combinations thereof.

19. The article of claim 15 further comprising a dye layer on the oxide layer.

20. The article of claim 15, wherein the surface of the colored oxide layer has an Ra value from about 0.01 microns to about 0.1 microns.
